(19) United States
(12) Patent Application Publication
(10) Pub. No.: US 2025/0013441 A1
(43) Pub. Date: Jan. 9, 2025

(54) Automated Policy Compliance Using Large Language Models

(71) Applicant: Google LLC, Mountain View, CA (US)

(72) Inventors: Christopher Ian Schneider, Edinburgh (GB); Bessie S. Jiang, London (GB); J. Nicolas Watson, Reston, VA (US)

(21) Appl. No.: 18/218,302

(22) Filed: Jul. 5, 2023

(51) Int. Cl. G06F 8/41

(52) U.S. Cl. CPC G06F 8/41

(57) ABSTRACT

A method includes generating a modeling language diagram that is indicative of a compiled version of program code. The modeling language diagram includes at least one node corresponding to at least one function in the program code. The method also includes identifying at least one function signature associated with anode state transition between nodes in the modeling language diagram. The method also includes identifying, using a large language model, a particular policy to attribute to the at least one function signature associated with the node state transition. The method further includes performing, using the large language model, a policy compliance operation that ensures a particular portion of the program code complies with the particular policy. The particular portion of the program code is associated with the node state transition. Performing the policy compliance operation includes generating a policy-compliant version of the particular portion of the program code.

### BACKGROUND

Software developers often have to consider a variety of different policies when building program code. For example, each function associated with a particular program code may be subject to compliance with a variety of different policies. As the number of policies that have to be considered by software developers increases, it becomes increasingly difficult to verify that program code is in compliance with each policy. Similarly, as program code is updated or becomes more complex, it becomes increasingly difficult to verify that each portion of the program code remains in compliance with each policy. To add even more complexity, program code that was previously in compliance with policies may fall out of compliance if policy changes occur.

The above scenarios make it increasingly difficult to achieve and verify policy compliance at all times. As a result, a significant amount of time and resources are attributable to achieving and verifying policy compliance.

### SUMMARY

An integrated development environment can compile program code and abstract (e.g., generate) a modeling language diagram based on the compiled program code. The modeling language diagram can include node states that correspond to different functions in the program code. Each node state has a function signature that is usable to identify one or more policies for the underlying functions. If attributes of a particular node state transition between a node of type A to a node of type B indicate that the underlying functions are not in compliance with a particular policy, a large language model can generate one or more security controls that are usable to update the attributes of the particular node state transition. For example, data associated with the particular policy can be used as an input to the large language model. Based on the input, the large language model can generate one or more security controls that can update the particular node state transition into a policy-compliant node state transition. The policy-compliant node state transition can be used to generate policy-compliant program code. To illustrate, a large language model can generate policy-compliant program code based on the original program code that is not in compliance with the particular policy and based on the policy-compliant node state transition. The policy-compliant program code can be presented to a user in the integrated development environment as a suggestion for modifying the program code to comply with the particular policy.

In a first example embodiment, a method includes generating, by a processor, a modeling language diagram that is indicative of a compiled version of program code. The modeling language diagram includes at least one node corresponding to at least one function in the program code. The method also includes identifying, by the processor, at least one function signature associated with a node state transition between nodes in the modeling language diagram. The method also includes identifying, by the processor and using a large language model, a particular policy to attribute to the at least one function signature associated with the node state transition. The method further includes performing, by the processor and using the large language model, a policy compliance operation that ensures a particular portion of the program code complies with the particular policy. The particular portion of the program code is associated with the node state transition. Performing the policy compliance operation includes generating a policy-compliant version of the particular portion of the program code.

In a second example embodiment, a system includes a memory and a processor coupled to the memory. The processor is configured to generate a modeling language diagram that is indicative of a compiled version of program code. The modeling language diagram includes at least one node corresponding to at least one function in the program code. The processor is also configured to identify at least one function signature associated with a node state transition between nodes in the modeling language diagram. The processor is further configured to identify, using a large language model, a particular policy to attribute to the at least one function signature associated with the node state transition. The processor is also configured to perform, using the large language model, a policy compliance operation that ensures a particular portion of the program code complies with the particular policy. The particular portion of the program code is associated with the node state transition. Performing the policy compliance operation includes generating a policy-compliant version of the particular portion of the program code.

In a third example embodiment, a non-transitory computer-readable medium includes instructions that, when executed by a processor, cause the processor to perform operations. The operations include generating a modeling language diagram that is indicative of a compiled version of program code. The modeling language diagram includes at least one node corresponding to at least one function in the program code. The operations also include identifying at least one function signature of a node state transition between nodes in the modeling language diagram. The operations also include identifying, using a large language model, a particular policy to attribute to the at least one function signature associated with the node state transition. The operations further includes performing, using the large language model, a policy compliance operation that ensures a particular portion of the program code complies with the particular policy. The particular portion of the program code is associated with the node state transition. Performing the policy compliance operation includes generating a policy-compliant version of the particular portion of the program code.

In a fourth example embodiment, a system may include various means for carrying out each of the operations of the first example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a computing system operable to automate program code policy compliance, in accordance with examples described herein.

FIG. 2 illustrates an example of a computing process for automating program code policy compliance, in accordance with examples described herein.

FIG. 3 illustrates another example of a computing process for automating program code policy compliance, in accordance with examples described herein.

FIG. 4 illustrates another example of a computing process for automating program code policy compliance, in accordance with examples described herein.

FIG. 5 is a diagram illustrating training and inference phases of a machine-learning model, in accordance with examples described herein.

FIG. 6 illustrates a flow chart, in accordance with examples described herein.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example,” “exemplary,” and/or “illustrative” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

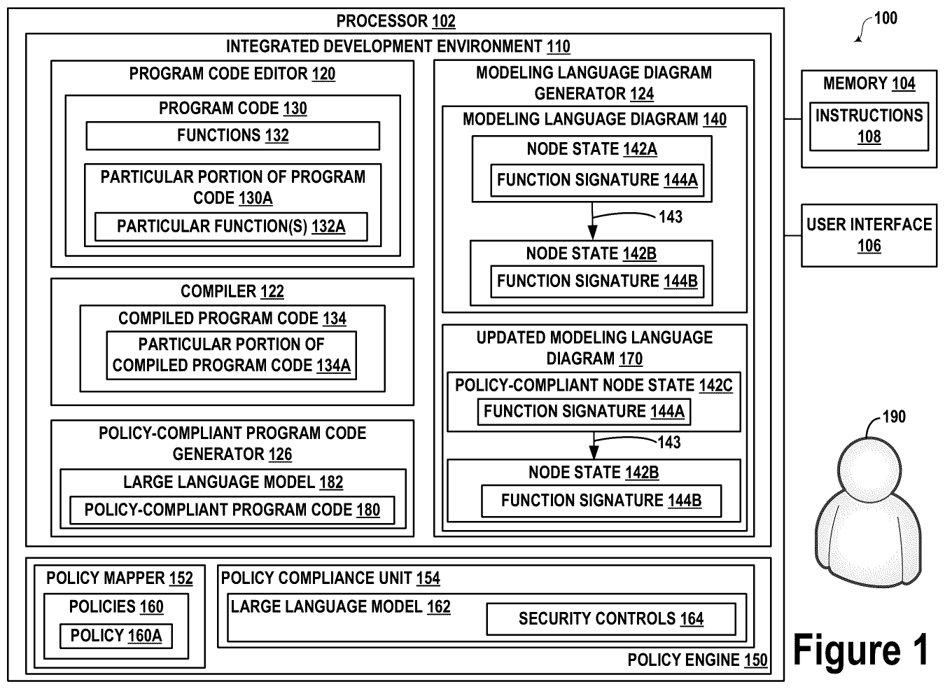

Particular embodiments are described herein with reference to the drawings. In the description, common features are designated by common reference numbers throughout the drawings. In some figures, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter. For example, referring to FIG. 1, multiple node states are illustrated and associated with reference numbers 142A and 142B. When referring to a particular one of these node states, such as the node state 142A, the distinguishing letter “A” is used. However, when referring to any arbitrary one of these node states or to these node states as a group, the reference number 142 is used without a distinguishing letter.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order. Unless otherwise noted, figures are not drawn to scale.

### I. OVERVIEW

The techniques described herein enable automated policy compliance verification for program code using large language models. In the context of software development, it may be difficult to attest that security controls are attributed to the program code. Furthermore, if the security controls are attributed to the program code, it can be relatively difficult to prove. As a result, policy compliance may be difficult to enforce and prove, which can result in program code vulnerabilities and security vulnerabilities.

However, as described herein, compliance can be achieved and proven by visualizing attack surfaces within software through Unified Modeling Language (UML) generation, dynamic evaluation of policies and security controls as appropriate to the use case of each node in the UML diagram, and automatic implementation of new controls through heuristic workflows, such as large language models. The automation of security controls helps reduce vulnerabilities and overhead associated with implementation. Additionally, the automation of compliance verification can institute a system for rapid change to code.

For example, according to the techniques described herein, a user can write or build program code (e.g., source code) in an integrated development environment, and a compiler can compile the program code (e.g., translate the source code into machine code) to generate a compiled version of the program code. In response to the compilation, the integrated development environment can generate (e.g., abstract) a modeling language diagram, such as a Unified Modeling Language (UML) diagram, that is indicative of the compiled version of the program code. In particular, the program code can include a plurality of functions, and the modeling language diagram can include nodes that are indicative of the functions.

As a non-limiting example, a particular portion of the program code can include (1) a modification function that modifies a first particular type of data into a second particular type of data, and (2) a write function that writes the second particular type of data into a specific location. In this non-limiting example, the first particular type of data can correspond to user profile data, the second particular type of data can correspond to modified user data having a format supported by a particular application, and specific location can correspond to a user database associated with the particular application. In this example, the modification function can be referred to as Node State (A) in the modeling language diagram, and the write function can be referred to as Node State (B) in the modeling language diagram. A state transition between Node State (A) and Node State (B) in the modeling language diagram can be referred to as Node State Transition (AB). It should be understood the above example is merely for illustrative purposes and should not be construed as limiting.

Each node state in the modeling language diagram can be assigned to a unique class of node states that have the same underlying function(s) and an identical parameter list. Each unique class of node states is identified by a unique function signature. For example, each time there is a node state in the modeling language diagram that has same underlying function(s) as the Node State (A) (e.g., the modification function) and has the same parameter list as the parameter list in the underlying function, the function signature of the node state will be the same as the function signature for the Node State (A). For ease of description, the function signature for the Node State (A) will be referred to as “Function Signature (A)”, and the function signature for the Node State (B) will be referred to as “Function Signature (B)”.

One or more function signatures associated with the node state transitions can be identified. As a non-limiting example, a processor can identify that the Function Signature (A) and the Function Signature (B) are associated with the Node State Transition (AB). In response to identifying the function signatures for the Node State Transition (AB), a policy engine can evaluate the Node State Transition (AB) to identify one or more policies to attribute to at least one of the associated function signatures. In particular, the policy engine can use a large language model to identify one or more policies to attribute to at least one of the associated function signatures when the modeling language diagram has a node state transition between a node type with the Function Signature (A) and a node type with the Function Signature (B). For example, during training, different function signatures and node state transitions (e.g., training data) can be provided as inputs to the large language model, and the function signatures and node state transitions can be associated with relevant policies. As more and more function signatures and node state transitions are provided to the large language model as training data, weights associated with the large language model can be finely tuned to accurately identify relevant policies for each function signature and node state transition. Thus, after being finely tuned to identify policies based on function signatures and node state transitions, the large language model can be a more efficient (e.g., faster and more accurate) way to identify policies than relying on a program developer to parse program code and attempt to identify all relevant policies to the program code.

In some embodiments, the modeling language diagram, or portion thereof, can be an input to the large language model. Based on the modeling language diagram, the large language model can identify the policies to attribute to the function signatures. The policies can correspond to security policies and/or security controls that should be implemented to ensure that the particular portion of the program code associated with the Node State Transition (AB) meets certain security requirements. Non-limiting examples of the policies can include ensuring that particular data is hidden/deleted, ensuring that scripts are not hidden, ensuring the certain functions are not executable, etc.

To ensure that the particular portion of the program code complies with the policies (e.g., meets the security requirements), the policy engine can perform a policy compliance operation. To illustrate, let's assume that one policy attributable to the Function Signature (A), when associated with the Node State Transition (AB), is that social security data has to be deleted when modifying the user profile data. In this example, to perform the policy compliance operation, the policy engine can evaluate the Node State (A) in the modeling language diagram to determine whether social security data is deleted when modifying the user profile data. In some scenarios, the policy engine can use a large language model to evaluate the Node State (A) to determine whether social security data is deleted. For example, the large language model can determine whether there are any attributes in the Node State (A) that indicate that social security data is deleted. During evaluation of the Node State (A), if it is determined that the underlying modification function deletes social security data, the policy engine can determine that the particular portion of the program code associated with the Node State (A) complies with the policies (e.g., meets the security requirements).

However, during evaluation of the Node State (A), if it is determined that the underlying modification function does not delete social security data, the policy engine can determine that the particular portion of the program code associated with the Node State (A) fails to comply with the policies (e.g., fails to meet the security requirements). In this scenario, the policy compliance operation can use the large language model to update the modeling language diagram such that the Node State (A) becomes a policy-compliant node state, and as a result, the resulting Node State Transition (AB) becomes a policy-compliant node state transition. To update the modeling language diagram in such a manner, the large language model can use the policy to generate/identify security controls usable to modify the Node State (A) in the modeling language diagram into a policy-compliant node state, and thus modify the corresponding Node State Transition (AB) into a policy-compliant node state transition. For example, the large language model can identify appropriate credentials for the Node State (A) and apply the appropriate credentials to the Node State (A).

The updated modeling language diagram, in particular, the policy-compliant node state, can be used to generate policy-compliant program code (e.g., new code) to replace the particular portion of the program code associated with the Node State (A). For example, a program code updater can use a large language model to generate the policy-compliant program code based on the updated modeling language diagram. In some examples, an input to the large language model can include the particular portion of the program code associated with the Node State (A). Thus, the large language model can generate the policy-compliant program code based on the original non-compliant program code.

Prior to replacing the particular portion of the program code (e.g., the original non-compliant program code) with the policy-compliant program code, the user can be prompted (in the integrated development environment) whether to accept the policy-compliant program code or whether to modify the policy-compliant program code. As such, the policy-compliant program code is presented as a modifiable suggestion to the user in the integrated development environment. In response to accepting the policy-compliant program code, the policy-compliant program code can replace the particular portion of the program code to achieve policy compliance.

Thus, the techniques described herein enable automated policy compliance verification for program code using large language models. In particular, large language models can be applied to node states in the modeling language diagram to determine whether emissions (i.e., node state transitions) associated with the node states comply with the policies of the corresponding function signature for the node states. If the emissions comply with the policies, the policy engine can determine that the underlying program code is compliant with the policies. However, if the emissions do not comply with the policies, the large language models can update/modify the node states in the modeling language diagram based on security controls to achieve compliance. The updated/modified node states can be used to generate policy-compliant program code that is presented as a suggestion to replace the underlying program code that is not compliant with the policies.

As a result, instead of the user actively engaging in the time-consuming process or rewriting/rebuilding program code to comply with the policies and security requirements, large language models are used to suggest policy-compliant program code to the user. Thus, the techniques described herein reduce the amount of time that users (e.g., software developers) have to devote to ensuring the program code complies with different policies by automating policy compliance based on the large language models.

### II. EXAMPLE COMPUTING SYSTEMS

FIG. 1 illustrates an example of a computing system 100 operable to automate program code policy compliance. The computing system 100 includes a processor 102, a memory 104 coupled to the processor 102, and a user interface 106 coupled to the processor 102. The memory 104 can correspond to a non-transitory computer-readable medium that includes instructions 108 executable by the processor 102 to perform the operations described herein.

The computing system 100 can be integrated into a computing device, such as a laptop computer, a desktop computer, a portable computing device, a server, etc. Although the computing system 100 depicts three components (e.g., the processor 102, the memory 104, and the user interface 106), it should be understood that in other embodiments, the computing system 100 can include additional components. For example, in other embodiments, the computing system 100 can include a keypad, a mouse, a modem, additional processors, additional memories and/or storage devices, a display screen, etc.

The processor 102 can be configured to execute the instructions 108 in the memory 104 to operate an integrated development environment 110 and present the integrated development environment 110 to a user 190 via the user interface 106. The integrated development environment 110 can correspond to a software application that enables the user 190 (e.g., a software developer) to develop program code. In particular, the integrated development environment 110 can function as a single mechanism for the user 190 to build program code, edit program code, test program code, and package program code. In FIG. 1, the integrated development environment 110 includes a program code editor 120, a compiler 122, a modeling language diagram generator 124, and a policy-compliant program code generator 126. In other embodiments, the integrated development environment 110 can include other components, such as an interpreter, a debugger, etc.

The user 190 can build/write program code 130 in the program code editor 120 using the user interface 106. For example, in some scenarios, the user interface 106 can correspond to an input device, such as a keyboard, that enables the user 190 to enter the program code 130 into the program code editor 120. The program code editor 120 can correspond to a text-based program, such as a word processor. The program code 130 can be written in one of many types of programming languages, such as C++ programming language, C programming language, Java programming language, JavaScript programming language, etc. The programming languages described herein are merely for illustrative purposes and should not be construed as limiting. The techniques described herein can be implemented using any programming language.

The program code 130 can correspond to source code that includes a plurality of functions 132. Each function of the plurality of functions 132 can correspond to a different operation performed by the program code 130. For example, the plurality of functions 132 can correspond to a read function, a write function, a save-as function, an image generation function, a file rename function, etc. It should be understood that the specific functions 132 described herein are not intended to be limiting and are merely provided as examples. The techniques described herein are intended to cover all functions that can be performed using computer programming techniques.

In FIG. 1, the program code 130 can include a particular portion of program code 130A that includes one or more particular functions 132A. Thus, the particular portion of program code 130A is included in (e.g., is a subset of) the program code 130, and the one or more particular functions 132A is included in (e.g., is a subset of) the plurality of functions 132. As described herein, for non-limiting illustrative purposes only, the one or more particular functions 132A can include (1) a modification function that modifies a first particular type of data into a second particular type of data and (2) a write function that writes the second particular type of data into a specific location. However, it should be understood that the one or more particular functions 132A can include any function that can be performed using computer programming techniques.

In response to building the program code 130 in the program code editor 120, the compiler 122 can be configured to compile the program code 130 to generate compiled program code 134. For example, the compiler 122 can translate a programming language's source code (e.g., the program code 130) into machine code (e.g., the compiled program code 134). According to some embodiments, the compiled program code 134 can correspond to bytecode or computer object code that an interpreter (not shown) can convert into binary machine code to be read by a computer hardware processor. A particular portion of compiled program code 134A is included in (e.g., is a subset of) the compiled program code 134. The particular portion of compiled program code 134A corresponds to a compiled version of the particular portion of program code 130A. Thus, the particular portion of compiled program code 134A can be executable by a computer hardware processor to perform the one or more particular functions 132A.

The modeling language diagram generator 124 can be configured to generate a modeling language diagram 140 that is indicative of the compiled program code 134, and thus indicative of the program code 130. For example, during compilation, the modeling language diagram generator 124 can generate (e.g., abstract) the modeling language diagram 140 from the compiled program code 134 such that the modeling language diagram 140 includes a plurality of node states 142 (e.g., nodes) that are indicative of the plurality of functions 132 in the program code 130. In some scenarios, a particular node state 142 is indicative of a single function 132 in the program code 130. In other scenarios, a particular node state 142 is indicative of two or more functions 132 in the program code 130. According to some implementations, the modeling language diagram 140 corresponds to a UML diagram.

In the illustrative example of FIG. 1, the modeling language diagram 140 includes a node state 142A and a node state 142B. Although two node states 142 are illustrated, in other embodiments, the modeling language diagram 140 can include additional (or fewer) node states 142. The number of node states 142 in the modeling language diagram 140 can be based on the program code 130. Typically, although not always, lengthier program code 130 (indicative of more functions 132) may result in the modeling language diagram 140 having more node states 142 than shorter program code 130 (indicative of fewer functions 132). In the illustrative example of FIG. 1, the node state 142A and the node state 142B can be indicative of the one or more particular functions 132A. For example, the node state 142A can be indicative of the modification function in the one or more particular functions 132A, and the node state 142B can be indicative of the write function in the one or more particular functions 132A. It should be understood that the mappings between the node states 142 and the functions 132 are merely for illustrative purposes and should not be construed as limiting.

Each node state 142 can be assigned to a unique class of node states that have the same underlying function(s) 132 and an identical parameter list. Each unique class of node states is identified by a unique function signature 144. In FIG. 1, the node state 142A includes a function signature 144A, and the node state 142B includes a function signature 144B. Each function signature 144 includes a method name (e.g., a name for the underlying function(s)) and a parameter list. Node states 142 with different underlying functions or with different parameter lists cannot have the same function signature. For example, each time there is a random node state 142 in the modeling language diagram 140 that has same underlying function (e.g., the modification function) as the node state 142A and has the same parameter list as parameter list as the underlying function of the node state 142A, the function signature 144 of the random node state 142 will be the same as the function signature 144A for the node state 142A. Thus, in the illustrative example of FIG. 1, the function signature 144A for the node state 142A indicates a method name for the modification function. The function signature 144A includes a parameter list designating the first particular type of data as an input and the second particular type of data as an output. Additionally, the function signature 144B for the node state 142B indicates a method name for the write function. The function signature 144B also includes a parameter list indicating the specific location.

As illustrated in FIG. 1, the modeling language diagram 140 includes a node state transition 143 between the node state 142A and the node state 142B. Thus, the node state transition 143 indicates a transition between the underlying modification function of the node state 142A (indicated by the function signature 144A) and the underlying write function of the node state 142B (indicated by the function signature 144B). The processor 102 includes a policy engine 150 to identify and evaluate the function signatures 144 associated with the node state transition 143. In particular, the policy engine 150 can identify one or more policies 160 to attribute to at least one function signature 144A associated with the node state transition 143.

In some implementations, the policy engine 150 can use a large language model, such as a large language model 162, to identify the one or more policies 160 based on similar worded function signatures. For example, during training, different function signatures and node state transitions (e.g., training data) can be provided as inputs to the large language model 162, and the function signatures and node state transitions can be associated with relevant policies. As more and more function signatures and node state transitions are provided to the large language model 162 as training data, weights associated with the large language model 162 can be finely tuned to accurately identify relevant policies for each function signature and node state transition. Thus, after being finely tuned to identify policies based on function signatures and node state transitions, the large language model 162 can be a more efficient (e.g., faster and more accurate) way to identify policies 160 than relying on a program developer to parse program code and attempt to identify all relevant policies 160 to the program code 130.

The policies 160 can correspond to security policies and/or security controls that should be implemented to ensure that the program code 130 meets certain security requirements. To illustrate, the policy engine 150 includes a policy mapper 152. The policy mapper 152 can be configured to identify a particular policy 160A that should be attributed to the function signature 144A when the function signature 144A is part of the node state transition 143. That is, if the policy mapper 152 determines that there is a state transition between a node state having the function signature 144A and a node state having the function signature 144B, the policy mapper 152 attributes the particular policy 160A to the function signature 144A. To illustrate, let's assume that the particular policy 160A attributable to the function signature 144A is that social security data has to be deleted during the underlying modification function when the function signature 144A is part of the node state transition 143. It should be understood that the above example of the particular policy 160A is not intended to be limiting and is for illustrative purposes only. In other scenarios, the particular policy 160A can be different.

To ensure that the particular portion of program code 130A complies with the particular policy 160A (e.g., delete social security data), a policy compliance unit 154 of the policy engine 150 can perform a policy compliance operation. In this example, to perform the policy compliance operation, the policy compliance unit 154 can evaluate the node state 142A in the modeling language diagram 140 to determine whether social security data is deleted. In some scenarios, the policy compliance unit 154 can use a large language model 162 to evaluate the node state 142A to determine whether social security data is deleted. During evaluation of the node state 142A, if the policy compliance unit 154 determines that the underlying modification function deletes social security data, the policy compliance unit 154 can determine that the particular portion of program code 130A associated with the node state 142A complies with the particular policy 160A.

However, if the policy compliance unit 154 determines that the underlying modification function does not delete social security data, the policy compliance unit 154 can determine that the particular portion of program code 130A associated with the node state 142A fails to comply with the particular policy 160A. In this scenario, the policy compliance unit 154 can use the large language model 162 to update the modeling language diagram 140 such that the node state 142A becomes a policy-compliant node state 142C, and as a result, the node state transition 143 becomes policy-compliant. To update the modeling language diagram 140 in such a manner, the large language model 162 can generate security controls 164 associated with the particular policy 160A to modify the node state 142A in the modeling language diagram 140 into the policy-compliant node state 142C. For example, the large language model 162 can identify appropriate credentials to generate the policy-compliant node state 142C and apply the appropriate credentials to the node state 142A. In FIG. 1, the updated version of the modeling language diagram 140 is depicted as an updated modeling language diagram 170. In particular, the updated node state 142A is depicted as the policy-compliant node state 142C in the updated modeling language diagram 170.

The updated modeling language diagram 170, in particular, the policy-compliant node state 142C, can be used to generate policy-compliant program code 180 (e.g., new code). The policy-compliant program code 180 can be used to modify the particular portion of program code 130A (e.g., the original non-compliant program code) associated with the node state 142A. For example, the policy-compliant program code generator 126 can automate generation of the policy-compliant program code 180 based on the updated modeling language diagram 170. In particular, the policy-compliant program code generator 126 can use a large language model 182 to generate the policy-compliant program code 180. In some embodiments, the large language model 182 can correspond to the large language model 162. Inputs to the large language model 182 can include the particular portion of program code 130A (e.g., the original non-compliant program code) and data from the policy-compliant node state 142C. Thus, the policy-compliant program code 180 can be generated based on the particular portion of program code 130A (e.g., based on the original non-compliant program code). The policy-compliant program code 180 can correspond to a modified version of the particular portion of program code 130A. In particular, the policy-compliant program code 180 can include similar functions as the one or more particular functions 132A associated with the particular portion of program code 130A. However, unlike the particular portion of program code 130A, the policy-compliant program code 180 complies with the particular policy 160A (e.g., deletes the social security data during the modification function).

Modifying the particular portion of program code 130A can include replacing the particular portion of program code 130A with the policy-compliant program code 180. However, prior to replacing the particular portion of program code 130A with the policy-compliant program code 180, the user 190 can be prompted (in the integrated development environment 110) whether to accept the policy-compliant program code 180 or whether to modify the policy-compliant program code 180. As such, the policy-compliant program code 180 can be presented as a modifiable suggestion to the user 190. Thus, in some scenarios, the user 190 can be prompted to approve/edit the policy-compliant program code 180 prior to modifying the particular portion of program code 130A based on the policy-compliant program code 180. In these scenarios, the particular portion of program code 130A is modified based on the policy-compliant program code 180 in response to the user 190 approving the policy-compliant program code 180.

The techniques described with respect to FIG. 1 enable automated verification of policy compliance for program code using large language models 162, 182. In particular, the large language model 162 can be applied to the node states 142 in the modeling language diagram 140 to determine whether emissions associated with the node states 142 comply with the policies 160 of the corresponding function signature 144 for the node states 142. If the emissions comply with the policies 160, the policy engine 150 can determine that the underlying program code 130 is compliant with the policies 160. However, if the emissions do not comply with the policies 160, the large language model 162 can be used to update/modify the node states 142 in the modeling language diagram 140 based on security controls 164 to achieve compliance. The updated/modified node states (e.g. the policy-compliant node state 142C) can be used to generate policy-compliant program code 180 that is presented as a suggestion to replace the underlying program code 130 that is not compliant with the policies 160.

As a result, instead of the user 190 actively engaging in the time-consuming process or rewriting/rebuilding program code to comply with the policies 160 and security requirements, large language models 162, 182 are used to suggest policy-compliant program code 180 to the user 190. Thus, the techniques described with respect to FIG. 1 reduce the amount of time that users (e.g., software developers) have to devote to ensuring the program code complies with different policies 160 by automating policy compliance based on the large language models 162, 182.

### III. EXAMPLE COMPUTING PROCESSES

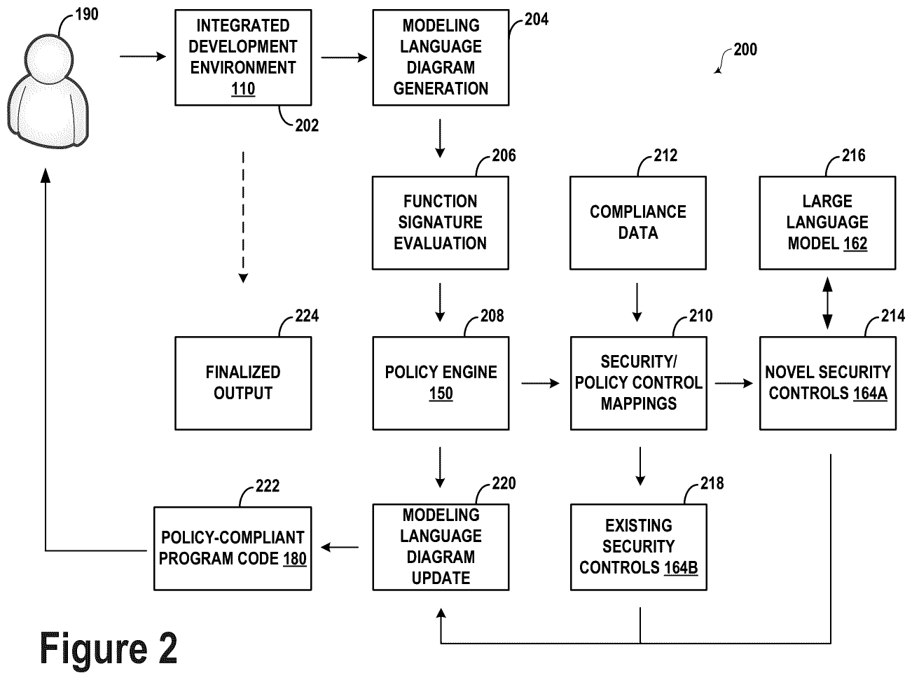

FIG. 2 illustrates an example of a computing process 200 for automating program code policy compliance. The computing process 200 can be performed by one or more of the components of the computing system 100 of FIG. 1.

According to the computing process 200, at block 202, the user 190 can build/write the program code 130 in the integrated development environment 110. For example, referring to FIG. 1, the user 190 can build/write program code 130 in the integrated development environment 110 using the user interface 106. In response to building the program code 130 in the integrated development environment 110, the compiler 122 can compile the program code 130 to generate the compiled program code 134. For example, the compiler 122 can translate the program code 130 into the compiled program code 134.

According to the computing process 200, at block 204, a modeling language diagram can be generated. For example, referring to FIG. 1, the modeling language diagram generator 124 can generate the modeling language diagram 140 that is indicative of the compiled program code 134. In particular, during compilation, the modeling language diagram generator 124 can generate (e.g., abstract) the modeling language diagram 140 from the compiled program code 134 such that the modeling language diagram 140 includes a plurality of node states 142 that are indicative of the plurality of functions 132 in the program code 130.

According to the computing process 200, at blocks 206 and 208, function signatures in the modeling language diagram can undergo evaluation by a policy engine. For example, referring to FIG. 1, the policy engine 150 identifies one or more policies 160 to attribute to at least one function signature 144A associated with the node state transition 143.

According to the computing process 200, at blocks 210, 212, and 218, security/policy control mappings can be performed. For example, referring to FIG. 1, the policy compliance unit 154 can access compliance data, at block 212, and map the compliance data to existing security controls 164B, at block 218. The existing security controls 164B can be used to update the modeling language diagram 140, at block 220. However, in some scenarios, there are no existing security controls 164B to implement the policies 160. For example, in some scenarios, there may not be any existing attributes for the node state 142A to indicate that social security data has to be deleted. In these scenarios, the large language model 162 generates novel security controls 164A for the policies 160, at blocks 214 and 216. For example, the large language model 162 can generate novel security controls 164A that are usable to update the modeling language diagram 140, at block 220.

According to the computing process 200, at block 220, the modeling language diagram can be updated. For example, referring to FIG. 1, the policy compliance unit 154 can use the security controls 164A, 164B associated with the particular policy 160A to modify the node state 142A in the modeling language diagram 140 into the policy-compliant node state 142C. The updated version of the modeling language diagram 140 is depicted as an updated modeling language diagram 170. In particular, the updated node state 142A is depicted as the policy-compliant node state 142C in the updated modeling language diagram 170.

According to the computing process 200, at block 222, the policy-compliant program code 180 can be generated. For example, referring to FIG. 1, the policy-compliant program code generator 126 can automate generation of the policy-compliant program code generator 126 based on the updated modeling language diagram 170. According to the computing process 200, the user 190 can be prompted (in the integrated development environment 110) whether to accept the policy-compliant program code 180 or whether to modify the policy-compliant program code 180. If the user 190 accepts the policy-compliant program code 180, the policy-compliant program code 180 can replace the particular portion of program code 130A (e.g., the non-compliant program code) as part of a finalized output, at block 224.

The techniques described with respect to FIG. 2 enable automated verification of policy compliance for program code using the large language model 162. For example, the large language model 162 can generate novel security controls 164A that are usable to update/modify the modeling language diagram 140 to achieve compliance with the policies 160. The updated/modified version of the modeling language diagram 140 (e.g., the updated modeling language diagram 170) can be used to generate policy-compliant program code 180 that is presented as a suggestion to replace the underlying program code 130 that is not compliant with the policies 160. As a result, instead of the user 190 actively engaging in the time-consuming process or rewriting/rebuilding program code to comply with the policies 160 and security requirements, large language models 162 are used to suggest policy-compliant program code 180 to the user 190. Thus, the techniques described with respect to FIG. 2 reduce the amount of time that users (e.g., software developers) have to devote to ensuring the program code complies with different policies 160 by automating policy compliance based on the large language model 162.

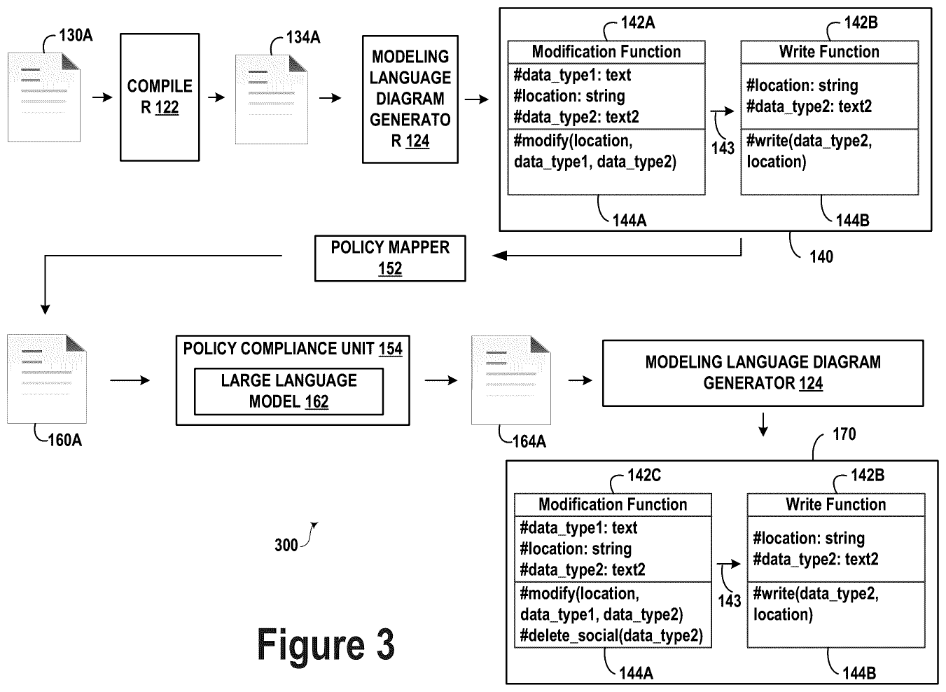

FIG. 3 illustrates another example of a computing process 300 for automating program code policy compliance. The computing process 300 can be performed by one or more of the components of the computing system 100 of FIG. 1. The computing process 300 described with respect to FIG. 3 focuses on automated policy-compliant node state generation for the particular portion of program code 130A. However, it should be understood that the computing process 300 can be extended to automate policy-compliant node state generation for different portions of the program code 130.

According to FIG. 3, the particular portion of program code 130A is provided to the compiler 122. As described above, the particular portion of program code 130A includes one or more particular functions 132A, such as the save-as function. The compiler 122 can compile the particular portion of program code 130A to generate the particular portion of compiled program code 134A. During compilation, or in response to compilation, the modeling language diagram generator 124 can generate the modeling language diagram 140 that includes the node state 142A indicative of the modification function and the node state 142B indicative of the write function.

As illustrated in FIG. 3, a non-limiting example of the node state 142A is depicted as a modification function and includes the function signature 144A. The node state 142A includes a list of attributes, such as the first particular data type (“data_type1”) of the user profile data, the location (“location”) of the user profile data, and the second particular data type (“data_type2”) of the modified user profile data. The function signature 144A also includes names for the underlying function (“modify”) and a parameter list. Additionally, a non-limiting example of the node state 142B is depicted as a write function and includes the function signature 144B. The node state 142B includes a list of attributes, such as the location (“location”) to write the modified user profile data and the second particular data type (“data_type2”) of the modified user profile data. The function signature 144A also includes names for the underlying function (“write”) and a parameter list.

The policy mapper 152 can identify the node state transition 143 and identify the particular policy 160A that should be attributed to the function signature 144A. That is, if the policy mapper 152 determines that there is a state transition between a node state having the function signature 144A and a node state having the function signature 144B, the policy mapper 152 attributes the particular policy 160A to the function signature 144A. According to the non-limiting example described above, the particular policy 160A (attributable to the function signature 144A) is social security data is to be deleted during the underlying modification function of the associated node state 142A. The policy compliance unit 154 can evaluate the node state 142A to determine whether the node state 142A indicates social security data is deleted. In some scenarios, the policy compliance unit 154 can use the large language model 162 to evaluate the node state 142A to determine whether social security data is deleted. For example, the large language model 162 can process the text of the node state 142A to determine whether the attributes indicate that social security data is deleted.

In the example of FIG. 3, there is no indication in node state 142A that social security data is deleted. As a result, the large language model 162 can use the particular policy 160A to generate/identify security controls 164A. The security controls 164A can be usable to update the node state 142A into the policy-compliant node state 142C. For example, the modeling language diagram generator 124 can update the node state 142A based on the security controls 164A to generate the policy-compliant node state 142C that indicates social security data is deleted. For example, the policy-compliant node state 142C is similar to the node state 142A, however, the underlying function in the function signature 144A of the policy-compliant node state 142 includes a function to delete social security data (“delete social”).

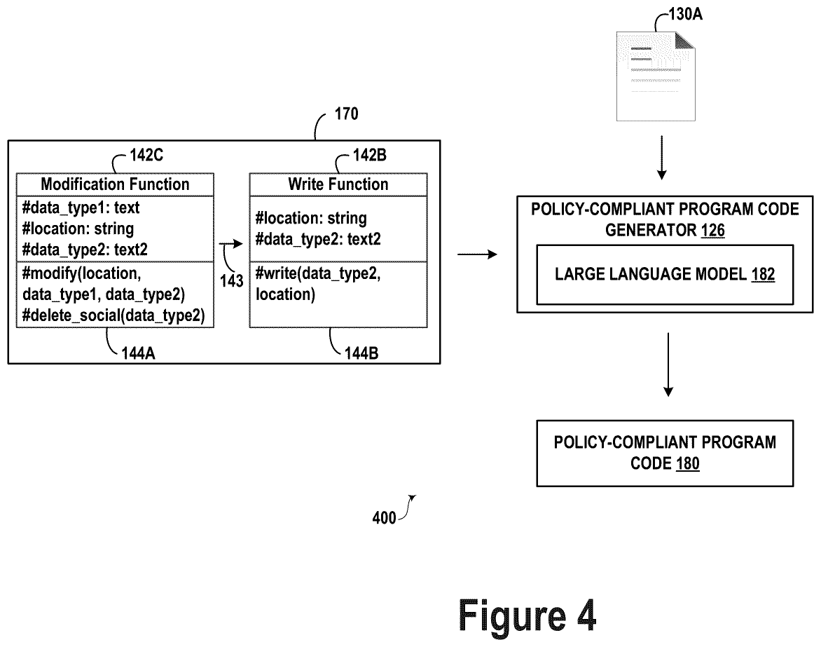

FIG. 4 illustrates another example of a computing process 400 for automating program code policy compliance. The computing process 400 can be performed by one or more of the components of the computing system 100 of FIG. 1. The computing process 400 described with respect to FIG. 4 focuses on automated policy-compliant program code generation for the particular portion of program code 130A. However, it should be understood that the computing process 400 can be extended to automate policy-compliant program code generation for different portions of the program code 130.

In FIG. 4, data from the policy-compliant node state 142C is provided to the policy-compliant program code generator 126. The policy-compliant program code generator 126 can use the large language model 182 to generate the policy-compliant program code 180. Inputs to the large language model 182 can include the particular portion of program code 130A (e.g., the original non-compliant program code) and data from the policy-compliant node state 142C. Thus, the policy-compliant program code 180 can be generated based on the particular portion of program code 130A (e.g., based on the original non-compliant program code). The policy-compliant program code 180 can correspond to a modified version of the particular portion of program code 130A. In particular, the policy-compliant program code 180 can include similar functions as the one or more particular functions 132A associated with the particular portion of program code 130A. However, unlike the particular portion of program code 130A, the policy-compliant program code 180 complies with the particular policy 160A.

The techniques described with respect to FIGS. 3-4 enable automated verification of policy compliance for program code using large language models 162, 182. In particular, the large language model 162 can be applied to the node states 142A to determine whether emissions associated with the node state 142A comply with the particular policy 160A corresponding to the function signature 144A. As illustrated in FIG. 3, if the emissions do not comply with the particular policy 160A (e.g., if the node state 142A does not indicate that social security data is deleted during modification), the large language model 162 can update/modify the node state 142A based on security controls 164 to achieve compliance. The updated/modified node states (e.g. the policy-compliant node state 142C) can be used to generate policy-compliant program code 180 that is presented as a suggestion to replace the underlying program code 130 that is not compliant with the policies 160.

As a result, instead of the user 190 actively engaging in the time-consuming process or rewriting/rebuilding program code to comply with the policies 160 and security requirements, large language models 162, 182 are used to suggest policy-compliant program code 180 to the user 190. Thus, the techniques described with respect to FIGS. 3-4 reduce the amount of time that users (e.g., software developers) have to devote to ensuring the program code complies with different policies 160 by automating policy compliance based on the large language models 162, 182.

### IV. EXAMPLE MACHINE-LEARNING PROCESS FOR LARGE LANGUAGE MODELS

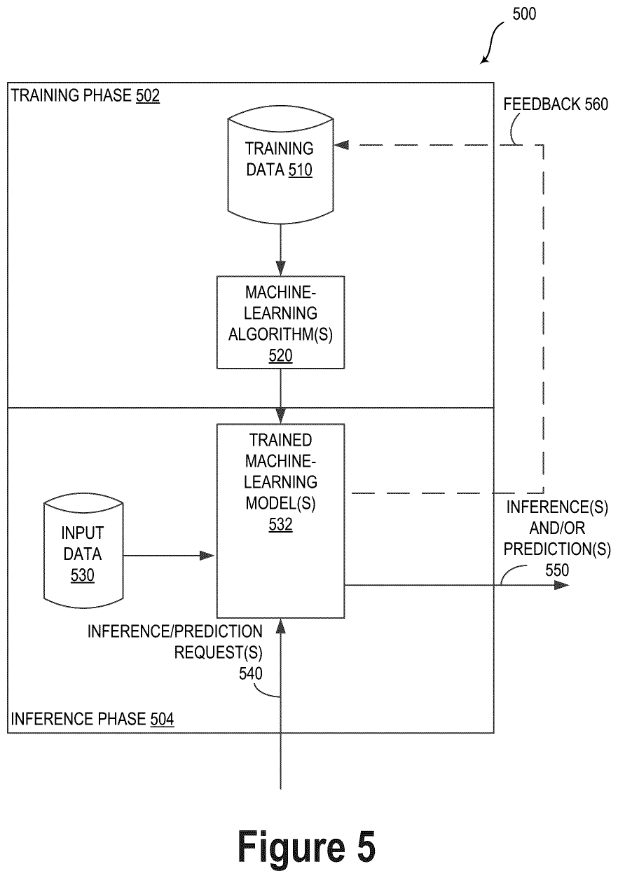

FIG. 5 shows a diagram 500 illustrating a training phase 502 and an inference phase 504 of trained machine-learning model(s) 532, in accordance with example embodiments. According to some examples, the trained machine-learning model(s) 532 can correspond to the large language model 162 and/or the large language model 182. Some machine-learning techniques involve training one or more machine-learning algorithms on an input set of training data to recognize patterns in the training data and provide output inferences and/or predictions about (patterns in the) training data. The resulting trained machine-learning algorithm can be termed as a trained machine-learning model. For example, FIG. 5 shows the training phase 502 where machine-learning algorithm(s) 520 are being trained on training data 510 to become trained machine-learning model(s) 532. Then, during the inference phase 504, the trained machine-learning model(s) 532 can receive input data 530 and one or more inference/prediction requests 540 (perhaps as part of the input data 530) and responsively provide as an output one or more inferences and/or prediction(s) 550.

As such, the trained machine-learning model(s) 532 can include one or more models of machine-learning algorithm(s) 520. The machine-learning algorithm(s) 520 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine-learning algorithm, and/or a heuristic machine-learning system). The machine-learning algorithm(s) 520 may be supervised or unsupervised, and may implement any suitable combination of online and offline learning.

In some examples, the machine-learning algorithm(s) 520 and/or the trained machine-learning model(s) 532 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up the machine-learning algorithm(s) 520 and/or the trained machine-learning model(s) 532. In some examples, the trained machine-learning model(s) 532 can be trained, reside and execute to provide inferences on a particular computing device, and/or otherwise can make inferences for the particular computing device.

During the training phase 502, the machine-learning algorithm(s) 520 can be trained by providing at least the training data 510 as training input using unsupervised, supervised, semi-supervised, and/or reinforcement learning techniques. Unsupervised learning involves providing a portion (or all) of the training data 510 to the machine-learning algorithm(s) 520 and the machine-learning algorithm(s) 520 determining one or more output inferences based on the provided portion (or all) of the training data 510. Supervised learning involves providing a portion of the training data 510 to the machine-learning algorithm(s) 520, with the machine-learning algorithm(s) 520 determining one or more output inferences based on the provided portion of the training data 510, and the output inference(s) are either accepted or corrected based on correct results associated with the training data 510. In some examples, supervised learning of the machine-learning algorithm(s) 520 can be governed by a set of rules and/or a set of labels for the training input, and the set of rules and/or set of labels may be used to correct inferences of the machine-learning algorithm(s) 520.

Semi-supervised learning involves having correct results for part, but not all, of the training data 510. During semi-supervised learning, supervised learning is used for a portion of the training data 510 having correct results, and unsupervised learning is used for a portion of the training data 510 not having correct results. Reinforcement learning involves the machine-learning algorithm(s) 520 receiving a reward signal regarding a prior inference, where the reward signal can be a numerical value. During reinforcement learning, the machine-learning algorithm(s) 520 can output an inference and receive a reward signal in response, where the machine-learning algorithm(s) 520 are configured to try to maximize the numerical value of the reward signal. In some examples, reinforcement learning also utilizes a value function that provides a numerical value representing an expected total of the numerical values provided by the reward signal over time. In some examples, the machine-learning algorithm(s) 520 and/or the trained machine-learning model(s) 532 can be trained using other machine-learning techniques, including but not limited to, incremental learning and curriculum learning.

In some examples, the machine-learning algorithm(s) 520 and/or the trained machine-learning model(s) 532 can use transfer learning techniques. For example, transfer learning techniques can involve the trained machine-learning model(s) 532 being pre-trained on one set of data and additionally trained using the training data 510. More particularly, the machine-learning algorithm(s) 520 can be pre-trained on data from one or more computing devices and a resulting trained machine-learning model provided to a particular computing device, where the particular computing device is intended to execute the trained machine-learning model during the inference phase 504. Then, during the training phase 502, the pre-trained machine-learning model can be additionally trained using the training data 510, where the training data 510 can be derived from kernel and non-kernel data of the particular computing device. This further training of the machine-learning algorithm(s) 520 and/or the pre-trained machine-learning model using the training data 510 of the particular computing device's data can be performed using either supervised or unsupervised learning. Once the machine-learning algorithm(s) 520 and/or the pre-trained machine-learning model has been trained on at least the training data 510, the training phase 502 can be completed. The trained resulting machine-learning model can be utilized as at least one of the trained machine-learning model(s) 532.

In particular, once the training phase 502 has been completed, the trained machine-learning model(s) 532 can be provided to a computing device, if not already on the computing device. The inference phase 504 can begin after training the machine-learning model(s) 532 are provided to the particular computing device.

During the inference phase 504, the trained machine-learning model(s) 532 can receive the input data 530 and generate and output one or more corresponding inferences and/or prediction(s) 550 about the input data 530. As such, the input data 530 can be used as an input to the trained machine-learning model(s) 532 for providing corresponding inference(s) and/or prediction(s) 550 to kernel components and non-kernel components. For example, the trained machine-learning model(s) 532 can generate inference(s) and/or prediction(s) 550 in response to one or more inference/prediction requests 540. In some examples, the trained machine-learning model(s) 532 can be executed by a portion of other software. For example, the trained machine-learning model(s) 532 can be executed by an inference or prediction daemon to be readily available to provide inferences and/or predictions upon request. The input data 530 can include data from the particular computing device executing the trained machine-learning model(s) 532 and/or input data from one or more computing devices other than the particular computing device.

If the trained machine-learning model 532 corresponds to the large language model 162, the input data 530 can include data associated with different policies 160. Other types of input data are possible as well. Inference(s) and/or prediction(s) 550 can include one or more security controls 164 for a given policy 160. If the trained machine-learning model 532 corresponds to the large language model 182, the input data 530 can include data associated with the policy-compliant node states 142C, data associated with modeling language diagrams 170, and/or data associated with the program code 130. Inference(s) and/or prediction(s) 550 can include one or more policy-compliant program code 180 for a given node state 142 or modeling language diagram 140, 170.

Inference(s) and/or prediction(s) 650 can include other output data produced by the trained machine-learning model(s) 532 operating on the input data 530 (and the training data 510). In some examples, the trained machine-learning model(s) 532 can use output inference(s) and/or prediction(s) 550 as input feedback 560. The trained machine-learning model(s) 532 can also rely on past inferences as inputs for generating new inferences.

Convolutional neural networks and/or deep neural networks used herein can be an example of the machine-learning algorithm(s) 520. After training, the trained version of a convolutional neural network can be an example of the trained machine-learning model(s) 532. In this approach, an example of the one or more inference/prediction requests 540 can be a request to predict security controls 164 and/or policy-compliant program code 180.

### V. ADDITIONAL EXAMPLE OPERATIONS

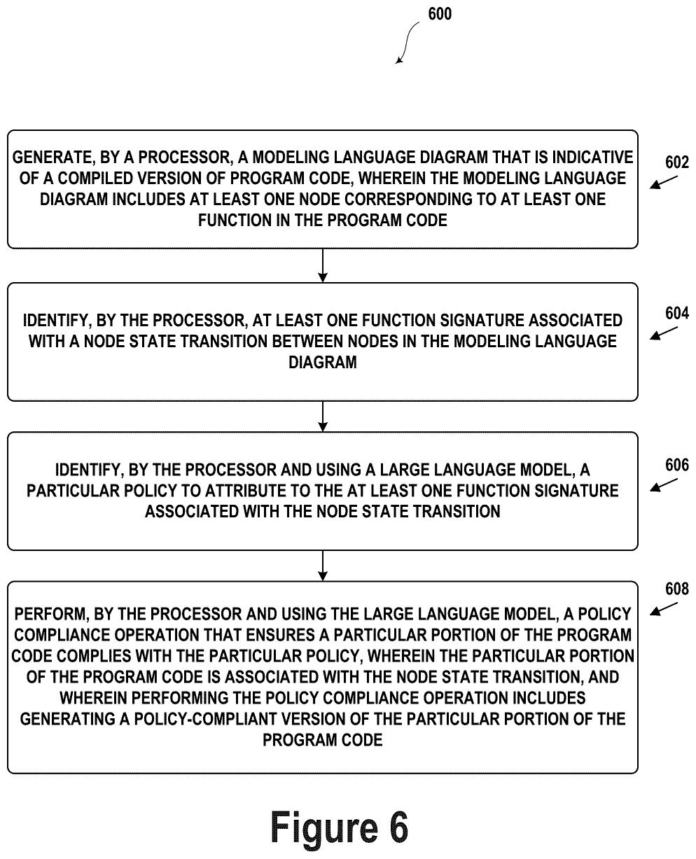

FIG. 6 illustrates a flow chart of a method 600 related to a new technology. The method 600 may be carried out by the computing system 100 among other possibilities. The embodiments of FIG. 6 may be simplified by the removal of any one or more of the features shown therein. Further, these embodiments may be combined with features, aspects, and/or implementations of any of the previous figures or otherwise described herein.

The method 600 includes generating, by a processor, a modeling language diagram that is indicative of a compiled version of program code, at block 602. The modeling language diagram includes at least one node corresponding to at least one function in the program code. For example, referring to FIG. 1, the modeling language diagram generator 124 can generate the modeling language diagram 140 that is indicative of the compiled program code 134 (e.g., a compiled version of the program code 130). The modeling language diagram 140 includes a plurality of nodes (e.g., node states 142A, 142B) corresponding to a plurality of functions (e.g., the modification function and the write function, respectively) in the program code 130.

The method 600 also includes identifying, by the processor, at least one function signature associated with a node state transition between nodes in the modeling language diagram, at block 604. For example, referring to FIG. 1, the policy engine 150 can identify the function signature 144A associated with the node state transition 143 in the modeling language diagram 140. The node state 142A can be indicative of at least one function 132A of the plurality of functions 132, such as the modification function.

The method 600 further includes identifying, by the processor and using a large language model, a particular policy to attribute to the at least one function signature associated with the node state transition, at block 606. For example, referring to FIG. 1, the policy mapper 152 can identify the particular policy 160A to attribute to the function signature 144A. According to one embodiment of the method 600, the particular policy corresponds to a security policy.

The method 600 also includes performing, by the processor and using the large language model, a policy compliance operation that ensures a particular portion of the program code complies with the particular policy, at block 608. The particular portion of the program code is associated with the node state transition, and performing the policy compliance operation includes generating a policy-compliant version of the particular portion of the program code. For example, referring to FIG. 1, the policy compliance unit 154 can perform the policy compliance operation that ensures the particular portion of program code 130A complies with the particular policy 160A.

According to one embodiment of the method 600, performing the policy compliance operation includes generating one or more security controls using a large language model. An input to the large language model can be based on the particular policy. For example, referring to FIG. 1, the policy compliance unit 154 can generate one or more security controls 164 using the large language model 162. Performing the policy compliance operation can also include generating a policy-compliant version of the node state transition based on the one or more security controls. For example, referring to FIG. 1, the modeling language diagram generator 124 can generate the policy-compliant node state 142C based on the one or more security controls 164. Generating the policy-compliant node state 142C can ensure that the node state transition 143 complies with the particular policy 160A. Performing the policy compliance operation can also include generating an updated version of the modeling language diagram based on the policy-compliant version of the node state transition. For example, referring to FIG. 1, the modeling language diagram generator 124 can generate the updated modeling language diagram 170 based on the policy-compliant node state 142C.

According to one embodiment of the method 600, performing the policy compliance operation includes generating policy-compliant program code using a large language model. An input to the large language model can include data from a policy-compliant version of the node state transition. For example, referring to FIG. 1, the policy-compliant program code generator 126 can generate the policy-compliant program code 180 using the large language model 182. An input to the large language model 182 can include data from the policy-compliant node state 142C. In some scenarios, another input to the large language model 182 includes the particular portion of program code 130A such that the policy-complaint program code 180 is based on the original non-compliant program code. Performing the policy compliance operation can also include modifying the particular portion of the program code based on the policy-compliant program code. For example, referring to FIG. 1, the processor 102 can modify the particular portion of program code 130A based on the policy-compliant program code 180.

According to one embodiment of the method 600, modifying the particular portion of program code 130A includes replacing the particular portion of program code 130A with the policy-compliant program code 180. In some scenarios, the user 190 can be prompted to approve the policy-compliant program code 180 prior to modifying the particular portion of program code 130A based on the policy-compliant program code. In these scenarios, the particular portion of program code 130A is modified based on the policy-compliant program code 180 in response to the user 190 approving the policy-compliant program code 180.

It should be understood that policy-complaint program code can be generated for each part of the program code 130 that is not in compliance with relevant policies. For example, in some scenarios, the method 600 can include applying a first flag to occurrences of the at least one function signature 144A in the modeling language diagram 140 that are in compliance with the particular policy 160A and applying a second flag to occurrences of the at least one function signature 144A in the modeling language diagram 140 that are not in compliance with the particular policy 160A. For each flagged occurrence of the function signature 144A that is not in compliance with the particular policy 160A, the method 600 can include modifying corresponding portions of the program code 130 based on the corresponding policy-compliant program code.

According to one embodiment, the method 600 can include changing one or more parameters associated with each occurrence of the function signature in the modeling language diagram. The method 600 can also include determining a deviation from a predicted output for each function signature in response to changing the one or more parameters. The method 600 can further include generating, using a large language model, policy-compliant program code that reduces the deviation. The method 600 can also include modifying portions of the program code corresponding to each occurrence of the function signature based on the policy-compliant program code.

The method 600 can enable automated verification of policy compliance for program code using large language models 162. In particular, large language models 162 can be applied to node states 142 in the modeling language diagram 140 to determine whether emissions associated with the node states 142 comply with the policies 160 of the corresponding function signature 144 for the node states 142. If the emissions comply with the policies 160, the policy engine 150 can determine that the underlying program code 130 is compliant with the policies 160. However, if the emissions do not comply with the policies 160, the large language models 162 can update/modify the node states 142 in the modeling language diagram 140 based on security controls 164 to achieve compliance. The updated/modified node states (e.g. the policy-compliant node state 142C) can be used to generate policy-compliant program code 180 that is presented as a suggestion to replace the underlying program code 130 that is not compliant with the policies 160.

As a result, instead of the user 190 actively engaging in the time-consuming process or rewriting/rebuilding program code to comply with the policies 160 and security requirements, large language models 162, 182 are used to suggest policy-compliant program code 180 to the user 190. Thus, the method 600 can reduce the amount of time that users (e.g., software developers) have to devote to ensuring the program code complies with different policies 160 by automating policy compliance based on the large language models 162, 182.

### VI. CONCLUSION

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for the purpose of illustration and are not intended to be limiting, with the true scope being indicated by the following claims.

What is claimed is:

1. A method comprising:
generating, by a processor, a modeling language diagram that is indicative of a compiled version of program code, wherein the modeling language diagram comprises at least one node corresponding to at least one function in the program code;
identifying, by the processor, at least one function signature associated with a node state transition between nodes in the modeling language diagram;
identifying, by the processor and using a large language model, a particular policy to attribute to the at least one function signature associated with the node state transition; and
performing, by the processor and using the large language model, a policy compliance operation that ensures a particular portion of the program code complies with the particular policy, wherein the particular portion of the program code is associated with the node state transition, and wherein performing the policy compliance operation comprises generating a policy-compliant version of the particular portion of the program code.

2. The method of claim 1, wherein performing the policy compliance operation comprises:
generating, by the processor and using the large language model, one or more security controls;
generating, by the processor, a policy-compliant version of the node state transition based on the one or more security controls; and
generating, by the processor, an updated version of the modeling language diagram based on the policy-compliant version of the node state transition.

3. The method of claim 1, wherein performing the policy compliance operation comprises:
generating, by the processor using the large language model, policy-compliant program code based on data from a policy-compliant version of the node state transition, and wherein the policy-compliant program code corresponds to the policy-compliant version of the particular portion of the program code; and
modifying, by the processor, the particular portion of the program code based on the policy-compliant program code.

4. The method of claim 3, wherein an input to the large language model includes the particular portion of the program code.

5. The method of claim 3, wherein modifying the particular portion of the program code comprises replacing the particular portion of the program code with the policy-compliant program code.

6. The method of claim 3, wherein a user is prompted to approve the policy-compliant program code prior to modifying the particular portion of the program based on the policy-compliant program code.

7. The method of claim 6, wherein the particular portion of the program code is modified based on the policy-compliant program code in response to the user approving the policy-compliant program code.

8. The method of claim 1, further comprising applying a flag to occurrences of the at least one function signature in the modeling language diagram that are not in compliance with the particular policy.

9. The method of claim 8, further comprising:
generating policy-compliant program code for each flagged occurrence of the at least one function signature, the policy-compliant program code generated using the large language model; and
for each flagged occurrence of the at least one function signature, modifying corresponding portions of the program code based on the corresponding policy-compliant program code.

10. The method of claim 1, wherein the modeling language diagram comprises a Unified Modeling Language (UML) diagram.

11. The method of claim 1, wherein the particular policy corresponds to a security policy.

12. The method of claim 1, further comprising:
changing one or more parameters associated with each occurrence of the at least one function signature in the modeling language diagram;
determining a deviation from a predicted output for each function signature in response to changing the one or more parameters;
generating, using the large language model, policy-compliant program code that reduces the deviation; and
modifying portions of the program code corresponding each occurrence of the at least one function signature based on the policy-compliant program code.

13. A system comprising:
a memory; and
a processor coupled to the memory, the processor configured to:
generate a modeling language diagram that is indicative of a compiled version of program code, wherein the modeling language diagram comprises at least one node corresponding to at least one function in the program code;
identify at least one function signature associated with a node state transition between nodes in the modeling language diagram;
identify, using a large language model, a particular policy to attribute to the at least one function signature associated with the node state transition; and
perform, using the large language model, a policy compliance operation that ensures a particular portion of the program code complies with the particular policy, wherein the particular portion of the program code is associated with the node state transition, and wherein performing the policy compliance operation comprises generating a policy-compliant version of the particular portion of the program code.

14. The system of claim 13, wherein, to perform the policy compliance operation, the processor is configured to:
generate, using the large language mode, one or more security controls;
generate a policy-compliant version of the node state transition based on the one or more security controls; and
generate an updated version of the modeling language diagram based on the policy-compliant version of the node state transition.

15. The system of claim 13, wherein, to perform the policy compliance operation, the processor is configured to:
generate, using the large language model, policy-compliant program code, wherein an input to the large language model includes data from a policy-compliant version of the node state transition, and wherein the policy-compliant program code corresponds to the policy-compliant version of the particular portion of the program code; and
modify the particular portion of the program code based on the policy-compliant program code.

16. The system of claim 15, wherein, to modify the particular portion of the program code, the processor is configured to replace the particular portion of the program code with the policy-compliant program code.

17. The system of claim 16, wherein a user is prompted to approve the policy-compliant program code prior to modifying the particular portion of the program based on the policy-compliant program code.

18. The system of claim 17, wherein the particular portion of the program code is modified based on the policy-compliant program code in response to the user approving the policy-compliant program code.

19. The system of claim 13, wherein, to perform the policy compliance operation, the processor is configured to:
apply a first flag to occurrences of the at least one function signature in the modeling language diagram that are in compliance with the particular policy; and
apply a second flag to occurrences of the at least one function signature in the modeling language diagram that are not in compliance with the particular policy.

20. A non-transitory computer-readable medium comprising instructions that, when executed by a processor, cause the processor to perform operations comprising:
generating a modeling language diagram that is indicative of a compiled version of program code, wherein the modeling language diagram comprises at least one node corresponding to at least one function in the program code;
identifying at least one function signature associated with a node state transition between nodes in the modeling language diagram;
identifying, using a large language model, a particular policy to attribute to the at least one function signature associated with the node state transition; and
performing, using the large language model, a policy compliance operation that ensures a particular portion of the program code complies with the particular policy, wherein the particular portion of the program code is associated with the node state transition, and wherein performing the policy compliance operation comprises generating a policy-compliant version of the particular portion of the program code.
